(19) United States
(12) Patent Application Publication
(10) Pub. No.: US 2004/0123594 A1
(43) Pub. Date: Jul. 1, 2004

(54) Hydrostatic transmission having a hydraulic dampening and neutral bleed mechanism

(76) Inventors: Douglas G. Williams, Bedford, IN (US); C. Paul Cox, Sellersburg, IN (US)

Correspondence Address: BAKER & DANIELS, 111 E. WAYNE STREET, SUITE 800, FORT WAYNE, IN, 46802

(21) Appl. No.: 10/331,717

(22) Filed: Dec. 30, 2002

(51) Int. Cl. F16D 31/02

(52) U.S. Cl. 60/468

(57) ABSTRACT

A hydrostatic transmission including a fluid motor in communication with a variable displacement fluid pump having a first displacement rate and a second greater displacement rate, a pump block having at least one fluid conduit through which fluid flows from the pump to the motor, an external fluid sump, a cylindrical pintle fixed to the block having a first bleed hole and a second bleed hole in communication with the first bleed hole, and a ring in sliding engagement with the pintle and having a slot in selective communication with the second bleed hole. The conduit and the sump are in communication through the bleed holes and the slot at the first displacement rate, and the fluid conduit and the sump are out of fluid communication at the second displacement rate.

### BACKGROUND OF THE INVENTION

1. Field of Invention

The present invention relates to hydrostatic transmissions intended primarily for use in the lawn and garden industry on tractors, riding lawnmowers, lawn and garden implements and the like.

2. Description of the Related Art

Hydrostatic transmissions transmit rotary mechanical motion, typically from an internal combustion engine, to fluid motion, typically via positive displacement pumps and motors using oil, and then back to rotary mechanical motion to rotate a drive axle in order to drive the vehicle. The hydrostatic transmission controls the output rotary mechanical motion such that varying output speeds in the forward and reverse directions are possible with a single speed input rotary mechanical motion. Such transmissions have utilized radial piston pumps and motors, axial piston pumps and motors and hybrid transmissions wherein the pump may be of one piston design, and the motor of another. The speed of the output of the transmission is typically controlled by varying the eccentricity of the pump track ring of a radial piston pump or the swash plate angle of an axial piston pump.

Hydrostatic transmissions have an inherent problem of not achieving, when placed in neutral, a condition in which the pump displacement is completely eliminated. Although the operator may shift the implement into neutral, thereby causing the hydrostatic transmission to be placed in neutral, there may still be some motion, or “creep”, of the implement. During forward or reverse operation of the hydrostatic transmission, this fluid is constantly moving through the system. In neutral, ideally, the displacement of the rotating pump is zero, and no fluid flows to the motor therefrom. Thus, no motion, however slight, is imparted to the axle. Should the rotating pump still have some slight displacement in neutral, however, fluid in one side of the hydrostatic system will become or remain slightly pressurized and cause the motor to slowly rotate, thereby creating forward or reverse motion of the wheels. What would be desirable is a hydrostatic transmission which allows any fluid displaced by the pump to be vented out of the hydrostatic system when the hydrostatic transmission is placed in the neutral position, thereby eliminating creep.

Yet another problem associated with the use of hydrostatic transmissions is the “jerking” effect created when the swash plate, or the pump track ring of a radial piston pump, is moved from neutral to forward or reverse and vice versa. Dampening of the engagement or disengagement of the hydrostatic transmission would eliminate the jerking or at least “soften” the transition to and from neutral. What would be desirable is a hydrostatic transmission which includes a mechanism for dampening the response of the motor to changes in pump displacement rates as the pump approaches and leaves neutral so that such jerking would be eliminated.

### SUMMARY OF THE INVENTION

The above-mentioned and described shortcomings are overcome by providing a hydrostatic transmission having a neutral bleed and hydraulic dampening mechanism which provides a fluid bleed from the fluid conduits between a pump and motor when in neutral and which allows fluid pressure to gradually build in and be released from the fluid conduits when the transmission is moved to and from neutral. The neutral bleed and hydraulic dampening mechanism includes a pintle fixed to the pump block and a ring in sliding engagement with the pintle. The pintle has fluid bleed holes in communication with the fluid conduit in the block and with the exterior of the pintle and the ring includes a slot that is in communication with an external fluid sump and in selective communication with a bleed hole of the pintle such that when the slot and a fluid bleed hole are aligned, fluid then bleeds to the sump and as the slot and fluid bleed hole move out of alignment, the bleeding slowly ceases.

The present invention provides a hydrostatic transmission including a fluid motor, a variable displacement fluid pump in fluid communication with the fluid motor and having a first fluid displacement rate and a second fluid displacement rate which is much greater than the first displacement rate, a block to which the pump is connected and having an outer surface, a fluid sump external to the block, a cylindrical pintle rigidly fixed to the block and having an outer circumferential surface, and a ring rotatable around the pintle and in sliding circumferential engagement with the pintle. The block is provided with at least one fluid conduit, fluid which flows from the pump to the motor flowing through the conduit. The pintle includes at least one first fluid bleed hole in communication with the conduit in the block and at least one second fluid bleed hole in communication with the first fluid bleed hole and extending to the outer circumferential surface. The ring has at least one slot open to the sump, the slot being moved into and out of alignment with the second bleed hole as the ring rotates, the ring position is correlated to the displacement of the pump. The conduit and the sump are in fluid communication through the first bleed hole, the second fluid bleed hole, and the slot when the pump is operating at its the first displacement rate and the slot is aligned with the second fluid bleed hole, and the fluid conduit and the sump are substantially out of fluid communication when the pump is operating at its the second displacement rate and the slot is substantially not aligned with the second fluid bleed hole.

The present invention further provides a hydrostatic transmission including a fluid motor, a variable displacement fluid pump in fluid communication with the fluid motor and having a first fluid displacement rate and a second fluid displacement rate which is much greater than the first displacement rate, a block on which the pump is mounted, a fluid sump external to the block, and means for placing the conduit and the sump in fluid communication when the pump is operating at its the first fluid displacement rate and gradually moving the conduit and the sump out of fluid communication in response to changes in the pump displacement rate. The block has a flat surface against which the pump is slidably engaged when the pump is operating at its first and second fluid displacement rates. The block is also provided with at least one fluid conduit which opens to the flat block surface through which fluid which flows from the pump to the motor, and the block has at least one fluid bleed hole open to the fluid sump. The means for placing the conduit and the sump in fluid communication is mounted on the exterior of the block and further includes means for placing the conduit and the sump substantially out of fluid communication at the pump second displacement rate.

The present invention further provides a method for dampening the response of a fluid motor to changes in a fluid pump displacement rate produced by movement between a neutral position and a drive position in a hydrostatic transmission, including providing at least one fluid conduit between the pump and the motor, rotating the pump while maintaining fluid communication with the conduit, operating the pump at a first displacement rate when in the hydrostatic transmission neutral position and the conduit and a fluid sump are in fluid communication, decreasing the fluid communication between the conduit and the sump while changing the hydrostatic transmission from its neutral position to its drive position, operating the pump at a second displacement rate when in the hydrostatic transmission drive position and the conduit and sump are substantially out of fluid communication, and increasing the fluid communication between the conduit and the sump while changing the hydrostatic transmission from its drive position to its neutral position.

An advantage provided by the present invention is that any fluid displaced or pressurized by the pump in neutral is bled from the hydrostatic transmission to an external sump, thereby preventing the occurrence of creep in the forward or reverse direction.

A second advantage provided by the present invention is that it dampens the effect of changes in pump displacement to and from zero displacement by allowing a portion of the hydrostatic fluid to bleed from the hydrostatic transmission as the transmission is shifted from neutral to a drive condition in forward or reverse, and vice versa.

### BRIEF DESCRIPTION OF THE DRAWINGS

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1 is a sectional top view of a reversible hydrostatic transmission module according to the present invention, attached to one embodiment of a differential axle unit, the assembly forming a hydrostatic transaxle;

FIG. 2 is a sectional top view of the hydrostatic transmission module of FIG. 1;

FIG. 3 is a sectional side view of the hydrostatic transmission module of FIG. 2 along line 3-3 thereof;

FIG. 4 is a sectional side view of the hydrostatic transmission module of FIG. 2 along line 4-4 thereof;

FIG. 5 is a side view of the hydrostatic transmission module of FIG. 2 along line 5-5 thereof;

FIG. 6 is a bottom perspective view of the hydrostatic transmission module of FIG. 2, the lower casing half and pump assembly thereof removed;

FIG. 7 is an enlarged fragmentary view of the hydrostatic transmission module of FIG. 6, showing components of the inventive hydraulic dampening and neutral bleed mechanism;

FIG. 8 is a sectional view of the hydraulic dampening and neutral bleed mechanism of FIG. 7, along line 8-8;

FIG. 9 is an enlarged fragmentary view of a portion of the hydrostatic transmission module of FIG. 7, the hydraulic dampening and neutral bleed mechanism being shown in the fully neutral position;

FIG. 10 is an enlarged fragmentary view of a portion of the hydrostatic transmission module of FIG. 7, the hydraulic dampening and neutral bleed mechanism being shown in the reverse position, wherein no fluid is being vented therethrough;

FIG. 11 is an enlarged fragmentary view of a portion of the hydrostatic transmission module of FIG. 7, the hydraulic dampening and neutral bleed mechanism approaching the neutral position from the forward position; and

FIG. 12 is an enlarged fragmentary view of a portion of the hydrostatic transmission module of FIG. 7, the hydraulic dampening and neutral bleed mechanism approaching the neutral position from the reverse position.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate two embodiments of the invention and such exemplification is not to be construed as limiting the scope of the invention in any manner.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended.

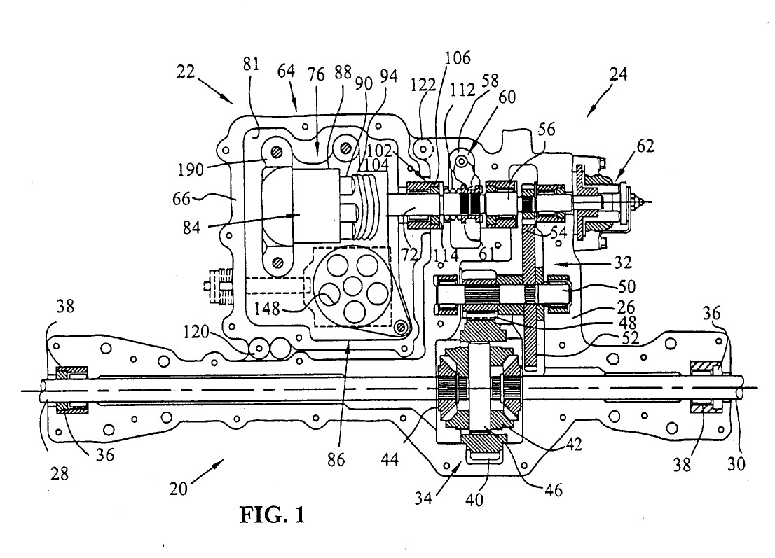

Referring first to FIG. 1, transaxle 20 comprises hydrostatic transmission module 22 and axle assembly 24. Axle assembly 24 includes casing 26 having upper and lower halves, split along a horizontal plane coincident with the rotational axes of axles 28 and 30. Disposed within casing 26 are reduction gear train 32 and differential mechanism 34. Axles 28 and 30 extend outwardly from differential mechanism 34 through a pair of openings in either end of casing 26 at which point axles 28 and 30 are sealed by seals 36 and supported by bearings 38.

Differential mechanism 34 is of a type known in the art and includes ring gear 40, bevel gears 42 and 44, and cross pin 46. Differential 34 is connected to small spur gear 48 that is splined to countershaft 50. The opposite end of countershaft 50 is similarly splined to large diameter gear 52 which is enmeshed with small diameter gear 54 splined to gear train input shaft 56.

Further included in casing 26 is space 58 which contains mechanical disconnect mechanism 60 of the type disclosed in U.S. Pat. No. 5,701,738, issued Dec. 30, 1997, and assigned to the assignee of the present application. The disclosure of this patent is expressly incorporated herein by reference. Additionally, transaxle 20 includes brake mechanism 62. The operation of the brake itself is the subject of U.S. Pat. No. 6,123,182, issued Sep. 26, 2000, and assigned to the assignee of the present application. The disclosure of this patent is expressly incorporated herein by reference. Transaxle 20 is further connected to hydrostatic transmission module 22, as described hereinbelow.

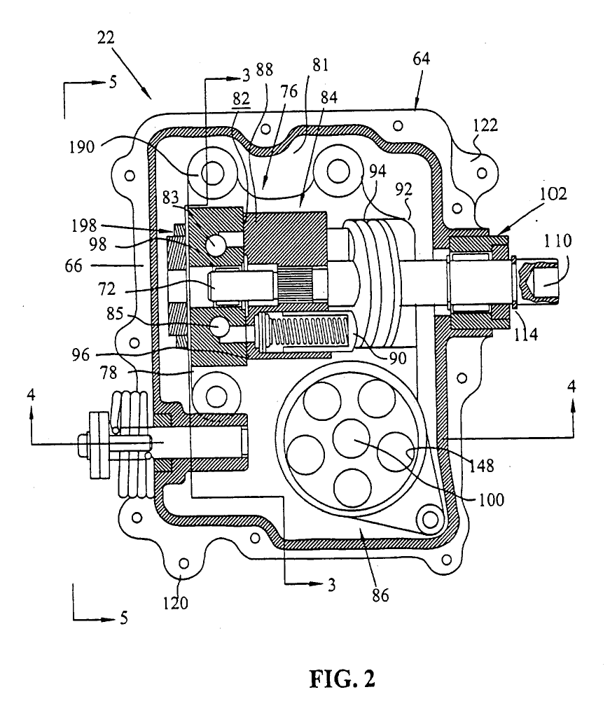

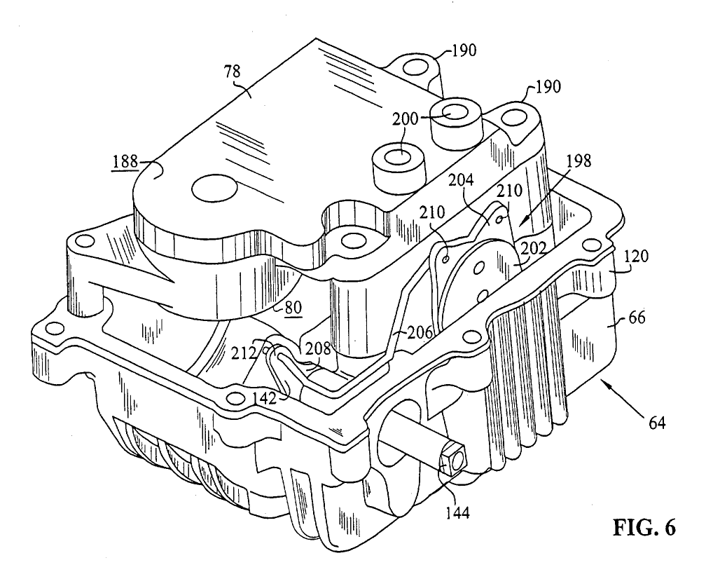

Referring now to FIGS. 2 through 5, hydrostatic transmission module 22 comprises a separate, self-contained casing 64 having two casing halves 66 and 68 split along horizontal interface 70 which is coplanar with the axis of motor output shaft 72. Casing halves 66 and 68 are connected together by a plurality of bolts 74 extending through lower casing half 68 and threadedly received in bores provided in upper casing half 66. Disposed within casing 64 is hydrostatic pump and motor mechanism 76 comprising center section, or block, 78 having pump mounting surface 80 and motor mounting surface 82 and internal conduits 83, 85 (FIG. 2) each hydraulically connecting a pair of arcuate slots (not shown) located in pump mounting surface 80 and motor mounting face 82. Pump and motor mechanism 76 further includes axial piston motor 84 and variable displacement pump 86. Mounted to the exterior of block 78 is hydraulic dampening and neutral bleed mechanism 198 having pintle 202 (FIG. 6) and ring 204 (FIG. 6), the operation of which will be described hereinbelow.

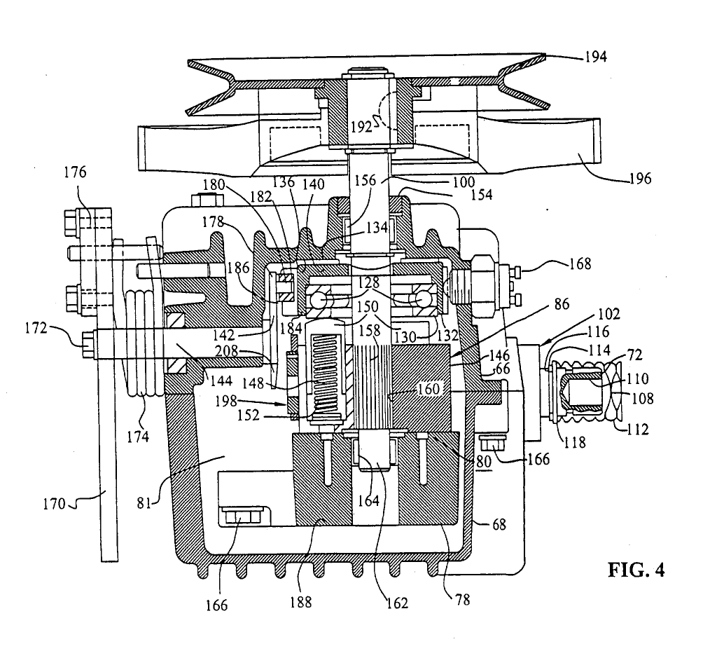

Axial piston motor 84 comprises rotatable cylinder 88 having a plurality of pistons 90 therein sliding against fixed swash plate assembly 92 and thrust bearing 94. Face 96 of rotatable cylinder 88 interfaces with motor mounting face 82 of center section block 78. Motor output shaft 72 extends through cylinder 88 and is supported by bearings 98 in center section 78. The axis of output shaft 72 is oriented 90° relative to the axis of pump input shaft 100, as best shown in FIG. 4. Motor output shaft 72 is also supported by sleeve and bearing assembly 102 fitted into casing 64 and extending into recess 106 formed in axle casing 26.

Connection of transmission module motor 84 with gear train 32 occurs through reduced, piloted end 108 of gear train input shaft 56 which is received within bore 110 in the end of motor output shaft 72. Shafts 56 and 72 are selectively rotatably fixed through collar 61 of mechanical disconnect mechanism 60 (FIG. 1) which, in its shown engaged position, rotatably couples shafts 56 and 72 through a splined connection. In the disengaged position of collar 61, shafts 56 and 72 are not rotatably coupled, and a mower in which transaxle 24 is installed may be easily pushed. Compression spring 112 is retained on shaft 72 by ring 114, disposed in groove 116, and flat washer 118, and biases collar 61 into its engaged position. Transmission casing 64 is mounted to transaxle casing 26 at two locations, 120 and 122, by corresponding overlapping extensions on casings 64 and 26 and bolts (not shown) which are driven from the bottom.

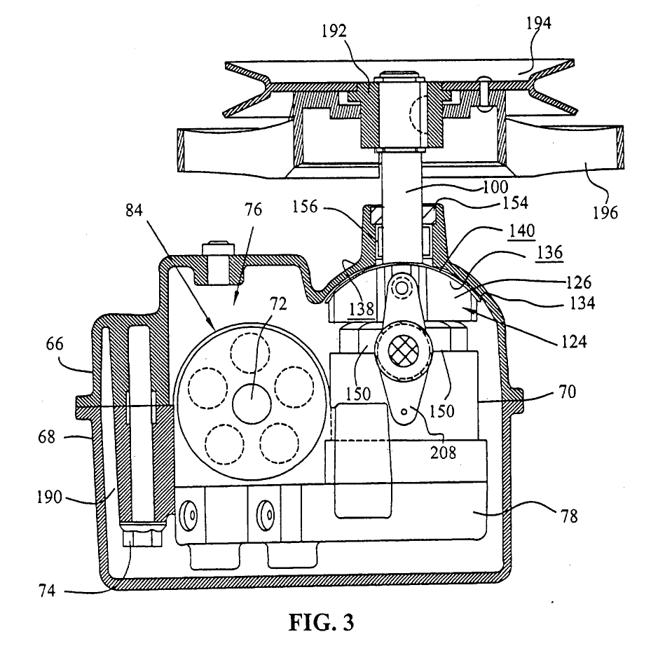

With reference to FIGS. 3 and 4, pump 86 is in mechanical communication with pivoting pump swash plate assembly 124, particularly swash plate 126. Swash plate assembly 124 includes swash plate 126, bearings 128, and bearing housing plates 130 and 132 encasing bearings 128. Swash plate 126 further includes arcuate bearing strips 134 with inner surfaces 136 attached to arcuate swash plate upper surface 138 and outer surface 140 interfacing with upper casing half 66. Pump swash plate assembly 124 will be variably tilted through the action of control rod 144 and control arm 142 in order to vary the displacement of pump 86. The operation of transmission module 22 is more fully described hereinbelow.

Pump 86 includes pump cylinder 146 rotatably driven by input shaft 100 and having a plurality of cylinders 148 within which are disposed pistons 150. Pistons 150 are urged against swash plate 126 by springs 152. Shaft 100 is sealed by seal 154 and is rotatably supported by bearing 156. Note that pump shaft 100 extends through swash plate assembly 124 and is splined to pump cylinder 146 via splined portion 158 on shaft 100 and splined portion 160 on pump cylinder 146. Typically, input shaft 100 further includes a first end keyed to common hub 192 of pulley 194 and fan 196 with pulley 194 being belt driven by a power source (not shown), thereby providing power to input shaft 100. Distal end 162 of shaft 100 is supported by bearing 164 in center section block 78. Screws 166, received in integral bosses 190, connect center section block 78 to upper casing half 66. Also located on upper casing half 66 is neutral switch 168 which cooperates with swash plate 126. The operation of the neutral switch itself is the subject of U.S. Pat. No. 6,378,300, issued Apr. 30, 2002, and assigned to the assignee of the present application. The complete disclosure of this patent is expressly incorporated herein by reference.

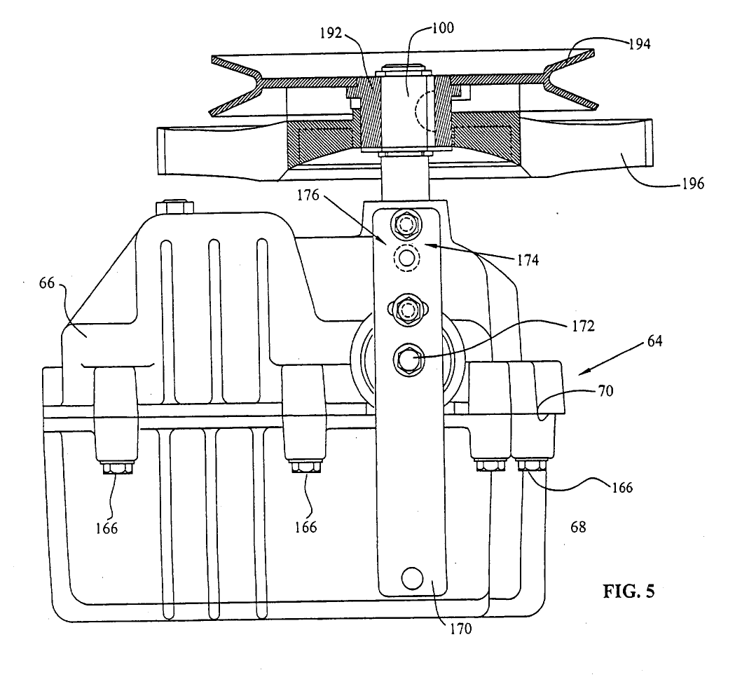

Referring now to FIGS. 4 and 5, shift lever 170 is attached to rotatable control arm 142 by screw 172, external of casing 26 and received in control rod 144. Shift lever 170 is returned to neutral by a conventional return-to-neutral spring mechanism 174, while adjustable plate 176 permits fine adjustment of neutral position. Control arm 142 is attached to control rod 144 and includes end 178 which swings through an arc about control rod 144 when shift lever 170 is rotated. Pin 180 is attached to end 178 of control arm 142 and extends into slot 182 provided on periphery 184 (FIG. 3) of swash plate 126. Friction roller 186 fits over pin 180 and freely rotates about pin 180 to engage with slot 182 of swash plate 126.

Selectively positioning control arm 142 causes swash plate 126 to variably tilt, and in turn, pistons 150, orbiting about input shaft 100, reciprocate with corresponding variable displacement, causing hydrostatic fluid in each cylinder 148 to pressurize as respective piston 150 is forced toward surface 80. Hydraulic fluid is drawn into a piston cylinder as the piston therein advances away from surface 80 under the influence of spring 152. The fluid flows to and from the pump through conduits 83 and 85, respectively, or vice versa depending on the direction swash plate 126 is tilted relative to its neutral position.

Referring now to FIG. 6, upper casing half 66 of self contained casing 64 is shown in an upside down position wherein lower surface 188 of center section 78 is shown. As described previously, center section 78 includes a pair of internal passages or conduits 83, 85 connecting pump 86 and motor 84. Make-up fluid is drawn into these conduits from sump 81 through check valves fitted in bores 200, in a known manner. Hydraulic dampening and neutral bleed mechanism 198 is mounted to the exterior of block 78 and includes pintle 202 surrounded by ring 204 which is in sliding circumferential engagement with pintle 202. The rotation of ring 204 relative to pintle 202 is accomplished through control rod 144 being rotated by an operator to select either the forward, neutral, or reverse position of the transmission. To facilitate such rotation, control rod 144 has been provided with portion 208 at an end thereof having hole 212 for receipt of one end of linkage 206. The other end of linkage 206 is received in hole 210 of ring 204 such that an operative connection is established between control rod 144 and ring 204.

It is to be noted that ring 204 includes two holes 210, one in each portion 211 thereof, and by providing such holes 210, hydraulic dampening and neutral bleed mechanism 198 may be utilized with either a right hand controlled transmission or a left hand controlled transmission because the location of control rod 144 varies between the right hand controlled versus left hand controlled transmissions. Thus, a hole 210 is provided in each portion 211 to provide ease of connection of linkage 206 to ring 204 and control rod 144 in either version of the transmission.

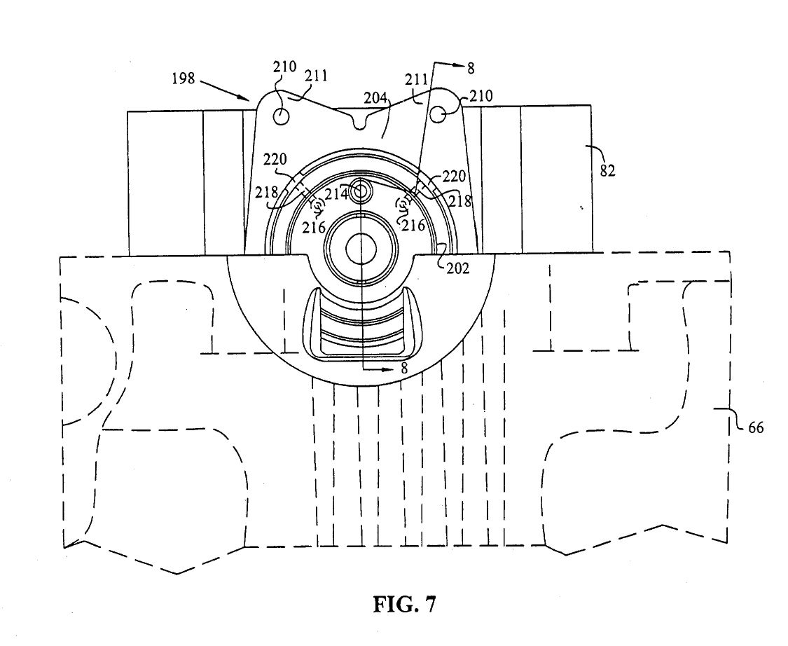

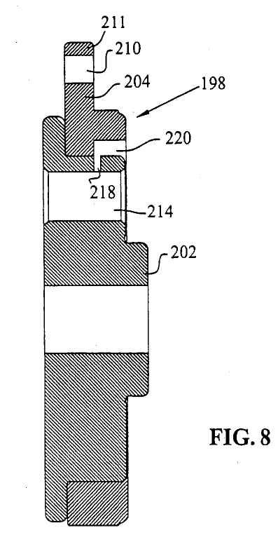

Pintle 202 is fixed to block 78 by a bolt inserted into bolt hole 214, as shown in FIG. 7. Pintle 202 further includes axially extending bleed holes 216 which are in communication with radial bleed holes 218 that open to the outer circumferential surface of pintle 202. Bleed holes 216 are in communication with bleed holes (not shown) bored into block 78 and in fluid communication with the internal fluid conduits 83, 85 that connect pump 86 and motor 84. Thus, fluid which flows through the internal fluid passages may also flow through the motor bleed holes and to bleed holes 216 and then through bleed holes 218 to the outer circumferential surface of pintle 202. In selective communication with bleed holes 218 are slots 220 in ring 204, which as shown in FIG. 8, extend slightly radially into ring 204 and extend axially inwardly of ring 204 to be in communication with bleed holes 218 when the neutral position of the transmission has been selected or to come into communication when transmission module 24 is in the process of being shifted to neutral.

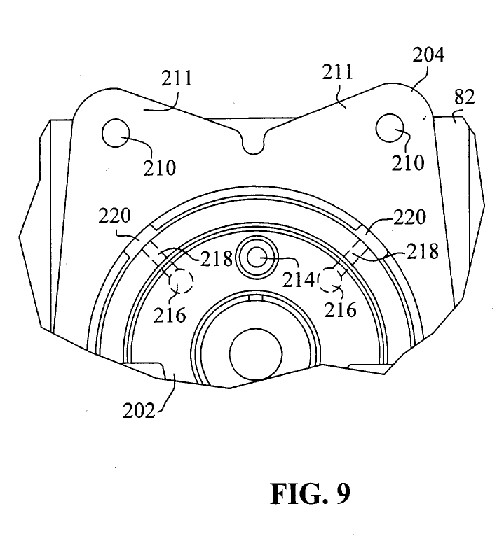

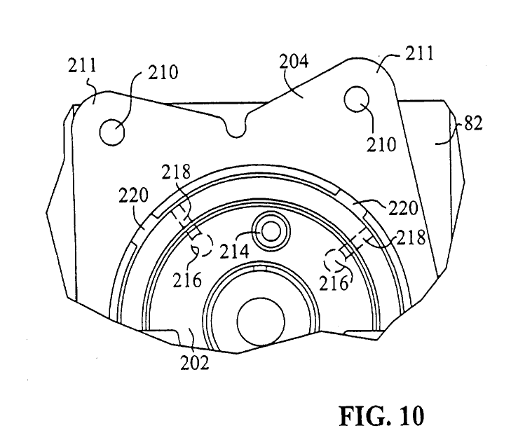

With reference to FIGS. 9 through 12, the operation of hydraulic dampening and neutral bleed mechanism 198 will be described. When control rod 144 has been rotated such that the neutral position of transmission 22 is selected, slots 220 are in full alignment and communication with bleed holes 218 and 216, as shown in FIG. 9, whereby any pressurized fluid which is within the internal passages between pump 86 and motor 84 is allowed to bleed from those internal passages to bleed holes 216 and 218 then through slots 220 to sump 81. Such fluid movement prevents any creep of the implement resulting from pressurized fluid within the system while in neutral, which would otherwise cause movement of motor 84. When a forward position of the transmission is selected, control rod 144 is rotated, causing ring 204 to be rotated as well resulting in slots 220 to be moved out of communication with bleed holes 218 and 216 and causing ring 204 to block bleed holes 216 and 218. Such a position may be seen in FIG. 10 wherein slots 220 are completely out of alignment with bleed holes 216 and 218, and, as such, no fluid from internal passages 83, 85 is allowed to bleed to fluid sump 81 since bleed holes 216 and 218 are physically blocked by ring 204, and all fluid is pumped from pump 86 to motor 84 for operation of the implement. Similarly, when the reverse position is selected and control rod 144 rotated with ring 204, the bleed holes are again out of alignment with slot 220 thereby preventing any fluid bleed.

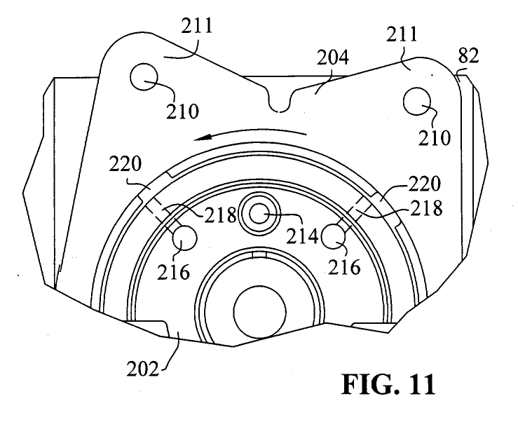

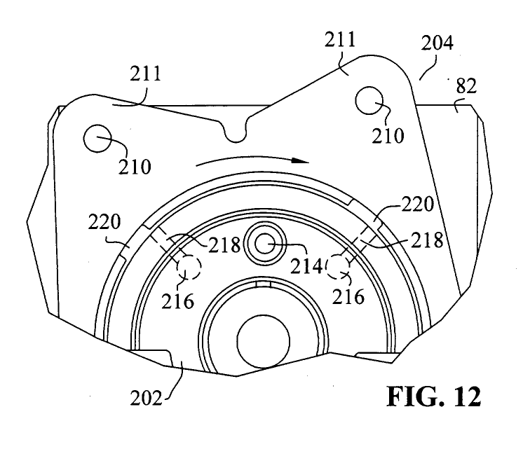

While the prevention of fluid bleed in the reverse or forward position allows for all fluid to be used for the operation of the implement, it can be undesirable to go quickly from a position where there is substantially no fluid displacement, i.e. the neutral position, to a position where there is fluid displacement by the pump, i.e. the forward and reverse positions since such a quick change from no fluid displacement to fluid displacement and vice versa can result in “jerkiness”. As such, hydraulic dampening is necessary to prevent the jerkiness associated with such change in fluid displacement rates. As shown in FIGS. 11 and 12, slots 220 and bleed holes 218 are coming into alignment with each other, or the transmission is being shifted into the neutral position. However, with movement in a direction opposite of the arrows, slots 220 and bleed holes 218 move away from alignment, or the transmissions is being shifted from neutral. If the operator has previously selected the neutral position and is now moving into either a forward or reverse position, as ring 204 is rotated, slots 220 are rotated out of alignment with bleed holes 218 and fluid which would have been bled in the neutral position, instead gradually begins to stop bleeding as either the forward or reverse position is approached. This gradual ceasing of fluid bleed prevents a great amount of fluid from suddenly flowing to motor 84 and causing the jerkiness associated with such sudden fluid flow, rather, the fluid flow to motor 84 begins gradually.

In a similar manner, when the operator has previously selected a forward or reverse position through movement of control rod 144, and then wishes to select the neutral position, if there were no dampening of that movement then there would be a sudden cut off of fluid flow within the internal passages. Thus, as ring 204 is rotated, slots 220 and holes 218 come into alignment through the rotation, with the fluid beginning to bleed through holes 216 and 218 to slots 220 and to sump 81 as ring 204 is rotated. Thus, fluid may begin to bleed from the internal passages before a full neutral position is achieved and allows for easing of the transmission into the neutral position rather than having a sudden stop and a sudden cut off of fluid flow from pump 86 to motor 84. FIG. 11 shows slots 220 and bleed holes 218 either coming into alignment when the transmission is moved from the forward position to the neutral position or moving out of alignment as the transmission is moved from a neutral position to a forward position. FIG. 12 shows a similar scenario with regard to the reverse position of the transmission.

It is to be noted that although the hydraulic dampening and neutral bleed mechanism 198 has been described with respect to an axial piston pump and motor structure, hydraulic dampening and neutral bleed mechanism 198 may also be utilized with a radial piston pump and motor structure. Such a radial piston and motor structure is disclosed in U.S. Pat. Nos. 5,177,967 and 5,373,697, assigned to the assignee of the present invention, and in U.S. Pat. No. 4,979,583, the complete disclosures of which are expressly incorporated herein by reference. When a radial piston structure is used, the connection between control rod 144 and bleed control ring 204 is replaced by a connection between the track ring of the radial piston pump and bleed control ring 204. Furthermore, hydraulic dampening and neutral bleed mechanism 198 may be used with other closed loop fluid systems which are used in the provision of power for lawn and garden implements.

It is also to be noted, that although the above descriptions of hydrostatic transmission 22 used with hydraulic dampening and neutral bleed mechanism 198 include pump 86 and motor 84 as being of the same type, mechanism 198 will still function effectively in those transmissions where pump 86 is of one type and motor 84 of another type. For example, in a situation wherein pump 86 is an axial piston pump and motor 84 a radial piston motor, mechanism 198 would be attached between pump 86 and motor 84 and provide the dampening and bleed features, as described above.

Although the above descriptions of mechanism 198 include pump 86 and motor 84 as being contained within a single modular hydrostatic transmission 22, mechanism 198 may be used in those situations in which pump 86 and motor 84 are separate, but are linked by fluid lines or are in fluid communication with each other. Hydraulic dampening and neutral bleed mechanism 198 allows fluid to be bled as it travels between pump 86 and motor 84 and is moved into its various positions by control rod 144. Thus, as long as mechanism 198 is able to allow fluid to be bled from the fluid conduits linking the pump and motor, as described above, then it is not required that pump 86 and motor 84 be located proximate each other.

While this invention has been described as having exemplary designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A hydrostatic transmission comprising:
a fluid motor;
a variable displacement fluid pump in fluid communication with said fluid motor, said pump having first fluid displacement rate and a second fluid displacement rate, said second fluid displacement rate being much greater than said first displacement rate;
a block to which said pump is connected and having an outer surface, said block provided with at least one fluid conduit, fluid which flows from said pump to said motor flowing through said conduit;
a fluid sump external to said block;
a cylindrical pintle rigidly fixed to said block and having an outer circumferential surface, said pintle including at least one first fluid bleed hole in communication with said conduit in said block and at least one second fluid bleed hole in communication with said first fluid bleed hole and extending to said outer circumferential surface;
a ring rotatable around said pintle and in sliding circumferential engagement with said pintle, said ring having at least one slot open to said sump, said slot being moved into and out of alignment with said second bleed hole as said ring rotates, said ring position being correlated to the displacement of said pump; and
wherein said conduit and said sump are in fluid communication through said first bleed hole, said second fluid bleed hole, and said slot when said pump is operating at its said first displacement rate and said slot is aligned with said second fluid bleed hole, and said fluid conduit and said sump are substantially out of fluid communication when said pump is operating at its said second displacement rate and said slot is substantially not aligned with said second fluid bleed hole.

2. The hydrostatic transmission of claim 1, wherein said pump has a neutral position and a drive position, said pump operating at its said first displacement rate when in its said neutral position, said pump operating at its said second displacement rate when in its said drive position.

3. The hydrostatic transmission of claim 2, wherein said hydrostatic transmission is reversible, said drive position is one of a forward and a reverse position, and said block is provided with two fluid conduits, whereby fluid which flows from said pump to said motor flowing through one of said fluid conduits when said pump is in its said forward position and through the other of said fluid conduits when said pump is in its said reverse position.

4. The hydrostatic transmission of claim 1, further comprising a casing, said pump and said block being located within said casing.

5. The hydrostatic transmission of claim 4, wherein said sump is located within said casing.

6. The hydrostatic transmission of claim 4, wherein said motor is located within said casing.

7. The hydrostatic transmission of claim 6, wherein said motor is mounted to said block.

8. The hydrostatic transmission of claim 1, wherein said pump includes a swash plate assembly, said first fluid displacement rate and said second fluid displacement rate being selected through movement of said swash plate assembly,
said swash plate assembly having a first position at which said pump operates at its said first displacement rate and a second position at which said pump operates at its said second displacement rate.

9. The hydrostatic transmission of claim 8, further comprising a movable control rod, said swash plate assembly operatively coupled to said control rod and being moved in response to movement of said control rod.

10. The hydrostatic transmission of claim 9, wherein said control rod movement is rotational.

11. The hydrostatic transmission of claim 10, wherein said control rod is linked to said ring.

12. The hydrostatic transmission of claim 11, wherein rotational movement of said control rod is translated to rotational movement of said ring.

13. The hydrostatic transmission of claim 12, wherein when said control rod is rotated such that said pump first displacement rate is selected, said slot in said ring is substantially aligned with said second bleed hole, and when said control rod is rotated such that said second displacement rate is selected, said slot in said ring is substantially out of alignment with said second bleed hole.

14. The hydrostatic transmission of claim 1, wherein said first fluid displacement rate is substantially zero.

15. A hydrostatic transmission comprising:
a fluid motor;
a variable displacement fluid pump in fluid communication with said fluid motor, said pump having a first fluid displacement rate and a second fluid displacement rate, said second fluid displacement rate being much greater than said first displacement rate;
a block on which said pump is mounted, said block having a flat surface against which said pump is slidably engaged when said pump is operating at its said first and second fluid displacement rates, said block provided with at least one fluid conduit which opens to said flat block surface, fluid which flows from said pump to said motor flowing through said conduit;
a fluid sump external to said block, said block having at least one fluid bleed hole open to said fluid sump; and
means for placing said conduit and said sump in fluid communication when said pump is operating at its said first fluid displacement rate and gradually moving said conduit and said sump out of fluid communication in response to changes in said pump displacement rate, said means for placing said conduit and said sump in fluid communication being mounted on the exterior of said block and further including means for placing said conduit and said sump substantially out of fluid communication at said pump second displacement rate.

16. The hydrostatic transmission of claim 15, wherein said pump further comprises a swash plate assembly having neutral and drive positions, said pump having its said first displacement rate in response to said swash plate assembly being in its said neutral position, said pump having its said second displacement rate in response to said swash plate assembly being in its said drive position.

17. The hydrostatic transmission of claim 16, wherein said conduit and said sump are placed into and substantially out of fluid communication simultaneously with movements of said swash plate assembly toward its said neutral and drive positions, respectively.

18. A method for dampening the response of a fluid motor to changes in a fluid pump displacement rate produced by movement between a neutral position and a drive position in a hydrostatic transmission, comprising:
providing at least one fluid conduit between the pump and the motor;
rotating the pump while maintaining fluid communication with the conduit;
operating the pump at a first displacement rate when in the hydrostatic transmission neutral position and the conduit and a external fluid sump are in fluid communication;
decreasing the fluid communication between the conduit and the sump while changing the hydrostatic transmission from its neutral position to its drive position;
operating the pump at a second displacement rate when in the hydrostatic transmission drive position and the conduit and sump are substantially out of fluid communication; and
increasing the fluid communication between the conduit and the sump while changing the hydrostatic transmission from its drive position to its neutral position.

19. The method of claim 18, further comprising:
allowing fluid displaced by the pump to flow to the sump when the hydrostatic transmission is in its neutral position; and
allowing fluid displaced by the pump to flow to the motor when the hydrostatic transmission is in its drive position.
